(19) United States
(12) Patent Application Publication
(10) Pub. No.: US 2019/0213909 A1
(43) Pub. Date: Jul. 11, 2019

(54) System and A Method for Analyzing Non-verbal Cues and Rating a Digital Content

(71) Applicant: Anurag Bist, Newport Beach, CA (US)

(72) Inventor: Anurag Bist, Newport Beach, CA (US)

(21) Appl. No.: 16/210,856

(22) Filed: Dec. 5, 2018

Related U.S. Application Data
(63) Continuation of application No. 13/791,903, filed on Mar. 8, 2013, now abandoned.
(60) Provisional application No. 61/608,665, filed on Mar. 9, 2012.

(51) Int. Cl. G09B 19/00; G06Q 50/00

(52) U.S. Cl. CPC G09B 19/00; G06Q 50/01

(57) ABSTRACT

A system and a method for capturing and analyzing the non-verbal and behavioral cues of the users in a network is provided. The sensors present in the client device capture the user behavioral and sensory cues as a reaction to the event, or a particular content. The client device then processes these sensory or behavior inputs or sends these captured sensory and behavioral inputs to the analysis module present in the server. The analysis module runs through a single or multiple sensory inputs on a per capture basis and derives analytics for the particular event it corresponds to. The analytics module consists of a Classification engine that first segments the initial captured cues into Intermediate States. Subsequent to this there is a Decision Engine that aggregates these Intermediate States from multiple instances of users and events, and other information about the user and the event to arrive at a Final State corresponding to the user reaction to the event.

### CROSS REFERENCE TO RELATED APPLICATIONS

This application is a continuation of U.S. patent application Ser. No. 13/791,903, filed Mar. 8, 2013, which claims the benefit of U.S. Provisional Patent Application Ser. No. 61/608,665, filed Mar. 9, 2012, the disclosures of which are incorporated by reference herein in their entireties.

### FIELD OF THE INVENTION

The present invention relates generally to a system and a method for analyzing and rating a digital content distributed over a shared network connection, and more particularly, to a method for generalizing the content analysis for personalization and ranking purposes using non-verbal and behavioral cues.

### BACKGROUND OF THE INVENTION

In an era of increased availability of multimedia content, our lives revolve around consuming content and information in a pervasive and 24/7 manner—be it while listening to news while driving, or texting, or checking Facebook statuses, or Twitter feeds while standing on airport lines, or doing the day to day professional activity where we interact with fellow co-workers or family on connected devices. We are living in a world of information and digital content overload. Digital content may represent movies, music, slides, games and other forms of electronic content. With the advancement of local area and wide area networking technologies, and cloud computing and storage technologies, digital content may be distributed on a wide variety of devices and a wide variety of formats. Most of this information distribution today happens in a digital and on-line fashion.

With the advancement in digital content distribution technology, there exists a need for efficient and personal information filtering that could satisfy each one of our needs in a customized fashion. A variety of solutions exist that tend to filter this kind of information in order to deliver personalized content. However, these methods are limited to using textual processing (e.g. Natural Language Processing techniques to parse textual information from digital content like Tweets, Blogs, etc.), or simple manual indications from people to elicit their reaction to the content (e.g. Likes and Dislikes on Web content, YouTube videos etc.)

Today the Internet and the infrastructure of wireless and wired connectivity connect individuals and the available content like never before. As people consume content at a rapid pace in a 24/7 manner, the reactions of people on consuming a specific content is being shared very rapidly as well. The growth of social media is opening new avenues for popularizing or monetizing such interactions. Most of the current interactions on the Internet are still limited to verbal, textual and to some extent visual (photo or video) inputs. The rating of content or events on the Internet is also limited to analytics based on these inputs. This invention deals with extending these analytics to a much richer kind of behavioral and sensory data captured from interactions of individuals on any connected environment. These interactions could be one-on-one communications between two individuals on a Web-conferencing platform (e.g. WebEx, Skype etc.), it could also be reactions captured for an individual consuming content on a connected device (e.g. watching a YouTube or Netflix movie on a laptop or iPAD), it could also be reactions of people in a broadcast scenario (e.g. a Webinar), or a person browsing some specific website or content, and any similar interaction over the internet. Using an infrastructure for capturing the sensory data captured from the individuals via the sensors present in the client devices that the individuals use to interact with a specific “event”, tagging this sensory data to the “event”, and then using intelligent analytics and steps to derive inferences about the individual's instantaneous or time averaged behavior that may be tagged to the event, or to the individual's evolving behavioral profile, or aggregating analytics multiple individuals reactions for the same “event” may provide useful information.

In the light of above discussion, a method and a system are needed which utilize non-verbal and behavioral cues of the users for generalizing the content analysis for personalization and ranking purposes. Such a system should provide a platform for capturing and analyzing the sensory and behavioral cues of an individual on reaction to events or content, and then presenting this analysis in a manner that could benefit the events, or the content, or any associated application that may be tied to the event or the content. Such a system should also provide (i) capture of the sensory and behavioral cues of the users during the event, or for the case of content, during watching the content; (ii) analysis of captured inputs and (iii) display of captured inputs on a sharing platform so that valuable insights can be derived based on the sensory and behavioral cues of each user that participated in the event, or had watched the digital content.

### BRIEF SUMMARY OF THE INVENTION

In view of the foregoing limitations, associated with the use of traditional technology, a method and a system is presented for capturing and analyzing the non-verbal and behavioral cues of the users in a network.

Accordingly the present invention provides a system that captures the reaction of users in form of non-verbal and behavioral cues and analyzes the reaction to provide information on the digital content in the network.

The present invention further provides a method of using non-verbal and behavioral cues of the user for generalizing the content analysis for personalization and ranking purpose.

Accordingly in an aspect of the present invention, a system for analyzing a digital content in an interactive environment is provided. Embodiments of the system have a module for distribution of content or event; a module to view the distributed content or event; a module to capture sensory and behavioral cue of the user while viewing the content, or participating in the event; an analysis module to analyze single or multiple sensory inputs and derive analytics; a display module to display the analysis result and other information on the content, or the event in a time aligned manner.

In another aspect of present invention, a method for analyzing a digital content in the network environment is provided. Embodiments of the method have the steps of distributing a digital content, or event, in the network environment; capturing the sensory or behavioral inputs of the user while watching the content; analyzing the input of the user to derive analytics of sensory inputs; displaying the analysis results on a dashboard; and communicating the analysis results within the network environment, or using it for some application related to the digital content or the event.

### BRIEF DESCRIPTION OF THE DRAWINGS

The invention will hereinafter be described in conjunction with the figures provided herein to further illustrate various non-limiting embodiments of the invention, wherein like designations denote like elements, and in which:

FIG. 1 illustrates a schematic representation of an interactive system for analytics of a digital content or an event based on behavioral and sensory cues in a connected network in accordance with an embodiment of the present invention.

FIG. 2 shows a user's profile in an online hosted service that provides a plurality of users to generate their individual profiles in the connected network, in accordance with an embodiment of the present invention.

FIG. 3 shows a module in the online hosted service that displays the digital streaming content distributed by a media repository and captures the instantaneous sensory or behavioral cues of the user, in accordance with an embodiment of the present invention.

FIG. 4 shows an exemplary representation of data processed by a behavioral classification engine, in accordance with an embodiment of the present invention.

FIGS. 5(a), 5(b) and 5(c) shows a graphical representation of intermediate emotional sub-states and the final emotional states of the user, in accordance with an embodiment of the present invention.

FIG. 6 shows a display dashboard displaying the analysis result of the captured sensory inputs, the sensory inputs, and the original event or the content, in accordance with an embodiment of the present invention.

FIG. 7 illustrates an analytic dashboard for comparing a number of advertisements posted by a Consumer Packaged Goods (CPG) company, in accordance with an embodiment of the present invention.

FIG. 8 illustrates an analytic dashboard for comparing effectiveness of a set of advertisement of a political campaign in accordance with an embodiment of the present invention.

FIG. 9 illustrates an analytic dashboard showing the impact of an advertisement on different segment of users, in accordance with an embodiment of the present invention.

### DETAILED DESCRIPTION OF INVENTION

In the following detailed description of embodiments of the invention, numerous specific details are set forth in order to provide a thorough understanding of the embodiments of the invention. However, it will be understood by a person skilled in art that the embodiments of invention may be practiced with or without these specific details. In other instances methods, procedures and components known to persons of ordinary skill in the art have not been described in detail so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method for deriving analytics of various sensory and behavioral cues inputs of the user in response to a digital content or an event by using an emotional detection engine, also known as emotion recognition engines such as for example openEar™. An “event” 104 is defined as any interaction that an individual may have in a connected medium via Internet, intranet, or a mobile connection. The “event” could be an individual doing a web conferencing or web chat, or an individual interacting with online digital media or an individual watching a video stored in a media repository, for instance a YouTube video, or a Netflix, using a laptop, internet tablet, or smart phone. The captured non-verbal cues are all kinds of sensory data that include video capture via a webcam, audio capture, GPS data, accelerometer data, haptic, tactile or any other kinds of sensory inputs. Once the data is collected from the individuals it is analyzed in a client application or a server application, or in a combination of both. The analysis of this non-verbal cue data could then be presented to the individual for asking more questions, or engaging the user in some way; the analysis is also used in tagging the “event” and the “profile” of the user; and is also used in aggregating multiple reactions of different users for the same event to derive inferences related to the event or the users, or an application connected to the event or the users. This invention describes a method and a system that makes the analysis of the non-verbal cues happen in a generic way. One part of the invention is the overall infrastructure of capture, tagging, analysis, and presentation of the non-verbal cues. The other part of the invention is the method of using the non-verbal cues to derive useful, meaningful, and consistent interpretations about the user behavior and the content in a generic manner.

In an embodiment of the present invention, the system comprises of an online service hosted in the Internet that provides the users of the online service to generate their online profiles. The profile of the user is provided with various security features so that it is accessible by the user only. However the user's profile can be viewable by other users of the online hosted services. The user can customize their profile and can set a privacy setting for their profiles. The privacy settings determines a pre-defined set of rules made by the user for his profile and thus through these rules, user's can control the access of their profile by other users in the online hosted service. The users can login into their profile in the online hosted service through a client device connected to the network through a server. The online hosted service provides a platform to the user where a user can interact with other users through one-to-one interactions or one-to-many interactions. Alternatively the online hosted service provides a platform whereby the users can access the digital content or event stored in a repository.

While interacting with other users or while watching the digital content or event, the users leave their emotional traces in form of facial or verbal or other sensory cues. The client device consists of a module to capture various sensory and behavioral cues of the user in response to the content or event or the interaction. The captured sensory and behavioral cues of the users are then processed in an analysis module in the client device that runs through a single or multiple sensory inputs on a per capture basis and derives analytics for the user, the corresponding event or the interaction. The client device further comprises a display dashboard that has an ability to show the derived analytics, the captured sensory and behavioral inputs, and the content or event. The client device is a device that has connectivity to a network or internet and has a user interface that enables the users to interact with other online users and to view the distributed content or event, and has the ability to capture and process input from the user. Online events and content are distributed in the interactive cloud network or other network through the server to the client devices. Online events may also comprise of one-to-one, or one-to-many interactions that includes but are not limiting to the Skype call or Webinars. The users' response to these events and content are captured by one or more sensors such as webcam, microphone, accelerometer, tactile sensors, haptic sensors and GPS present in the client devices in the form of users' input.

The present invention provides a system and a method of capturing one or many kinds of non-verbal cues in a manner so that they can be calibrated in a granular fashion with respect to time during the interaction of the user with the “Event”. Once this data is captured, the system provides a way to map the individual sensory captures into several “Intermediate states”. In one of the embodiments of the invention these “Intermediate states” may be related to instantaneous behavioral reaction of the user while interacting with the “Event”. The system also optionally applies a second level of processing that combines the time-aligned sensory data captured, along with the “Intermediate states” detected for any sensors as described in the previous step, in a way to derive a consistent and robust prediction of user's “Final state” in a time continuous manner. This determination of “Final state” from the sensory data captured and the “Intermediate states” is based on a sequence of steps and mapping applied on this initial data (sensory data captured and the “Intermediate states”). This sequence of steps and mapping applied on the initial data (sensory data and the “Intermediate states”) may vary depending on the “Event” or the overall context or the use case or the application. The Final state denotes the overall impact of the digital content or event on the user and is expressed in form of final emotional state of the user. This final state may be different based on different kinds of analysis applied to the captured data depending on the “Event”, the context, or the application. In one embodiment of the invention the determination of the “Final state” uses segment-based information about the users (age, gender, ethnicity, the social network, other personal likings etc.) that could either be given by the users themselves, or be generated by the collected sensory or other textual inputs from the users. An example of this could be applying a statistical averaging algorithm to the “Intermediate states” of a particular age of users, or a particular kind of content watched by a particular gender of users, to generate a given “Final State”. The invention uses the power of aggregation of numerous users rating the same content, or the same user rating multiple content, to create better behavioral state classification for the user, and better overall rating or meta-data for the content.

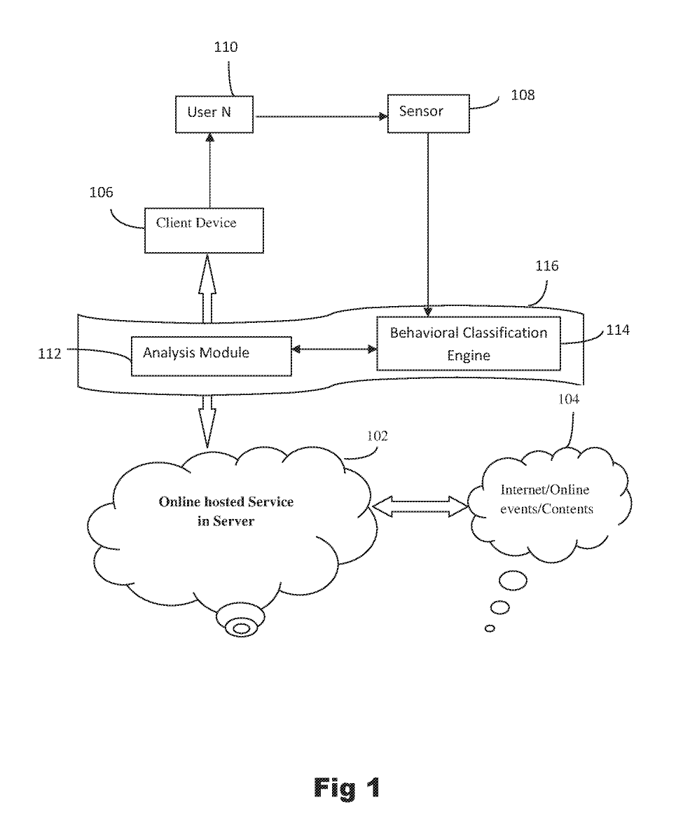

FIG. 1 illustrates a schematic representation of interacting system for deriving analytics of a digital content or an event based on behavioral and sensory cues in a connected network in accordance with an embodiment of the present invention. The system comprises an online hosted service 102 in a server that is connected via a website for distributing the online content and events 104 stored in a repository, or for facilitating the interaction of a user with other users in the connected network, such as in the case for video conferencing or webinar applications. The online hosted service in the server 102 comprises of a module for distributing the online content and events 104 among a plurality of client devices 106. The client device 106 has an interface that enables users 110 to view the distributed content and events 104 or to facilitate the user's interactions. The sensors 108 present in the client device 106 capture the user behavioral and sensory cues as a reaction during the event, or the reaction to the content being watched. The captured behavioral and sensory cue data are then processed by behavioral classification engine 114 that classifies the sensory data into a plurality of intermediate sub-states. These intermediate sub-states denote the instantaneous emotional reaction of a user to the online content or event 104. The intermediate sub-states mark an emotional footprint of users covering Happy, Sad, Disgusted, Fearful, Angry, Surprised, Neutral and other known human behavioral reactions. The behavioral classification engine 114 assigns a numerical score to each of the intermediate states that designates the intensity of a corresponding emotion. The classified intermediate states are then tagged granularly to the online content or event 104 in a continuous time frame manner.

The data from the behavioral classification engine 114, the instantaneous behavioral reaction and the behavioral reactions captured through the sensor 108 are then transferred to the analysis module 112. A series of mathematical operations are performed by the analysis module 112 on the data to derive a final emotional state of the user. The analysis module 112 generates the final emotional reaction of the user and intensity of the user's emotional reaction. The final emotional state of the user 110 is calculated by taking into consideration all the intermediate states along with their intensity and deriving a unique emotional state that designates the overall impact of online content or event 104 on the user 110.

The analysis module 112 runs through a single or multiple sensory inputs on a per capture basis and derives analytics for the particular event it corresponds to. The server 102 then displays the analysis result on display dashboard along with the captured sensory inputs, and the original event or content or a combination thereof in a time aligned manner. The display dashboard can be used to give real time feedback to the user in the client device, or could be used for enhancing any application related to the event or the content.

In an embodiment of the present invention, the analysis module 112 of the system has an ability to intelligently decide which sensory inputs may be relevant for which content or event, to intelligently decide which captured sensory inputs may be valid for analysis, to intelligently associate the captured sensory inputs and the associated analytics to the user from whom the inputs were recorded as well to the content or event the recordings corresponded to, and to do statistical processing of the analysis and tag it in a continuous fashion to the user and the content or the event it corresponds to, or any other application related to the content or the event.

In another embodiment of the present invention, the display dashboard has an ability to change the analytics based on the content or event, to customize the analytics based on requirements of the eventual application or the consumer of this analytics, to customize the display for any portion of the event, or for any specific sensory input, and to customize the display for multiple sensory inputs at a time and to show a cumulative analysis based on these multiple inputs.

The behavioral classification engine 114 and the analysis module 112 collectively process the behavioral and sensory cues of the user 110 to provide a meaningful expression and analysis of behavioral cues. The behavioral classification engine 114 and the analysis module 112 collectively can be referred as a processing unit 116 for processing the sensory and behavioral reaction of the user 110. The processing unit 116 can either reside completely in the client device 106 or can reside in the online hosted service in the server 106. The processing of sensory or behavioral reaction of the user 110 can be performed in the client device 106, or it can be in the server 108 or it can be done partly in the server 108 and partly in the client device 106. The place of processing will vary on the event 104 basis and will be dependent on the processing capability of the device and the available bandwidth in the network.

In another embodiment of the present invention the online content and events 104 is tagged by the derived final emotional state of the intermediate states with respect to each time frame. Additional the online content or event 104 is also tagged with individual user's reaction. The content's emotional state tag is further averaged based on all the inputs for all users. The content rating can further be weighted or segmented based on user demography, age, or relationship within a social network. A meta-data link is provided to the content that links the details of the content or event 104, tagging of user's reaction, tagging of final state of the user and the overall average rating from all the users that interacted with the online content or event.

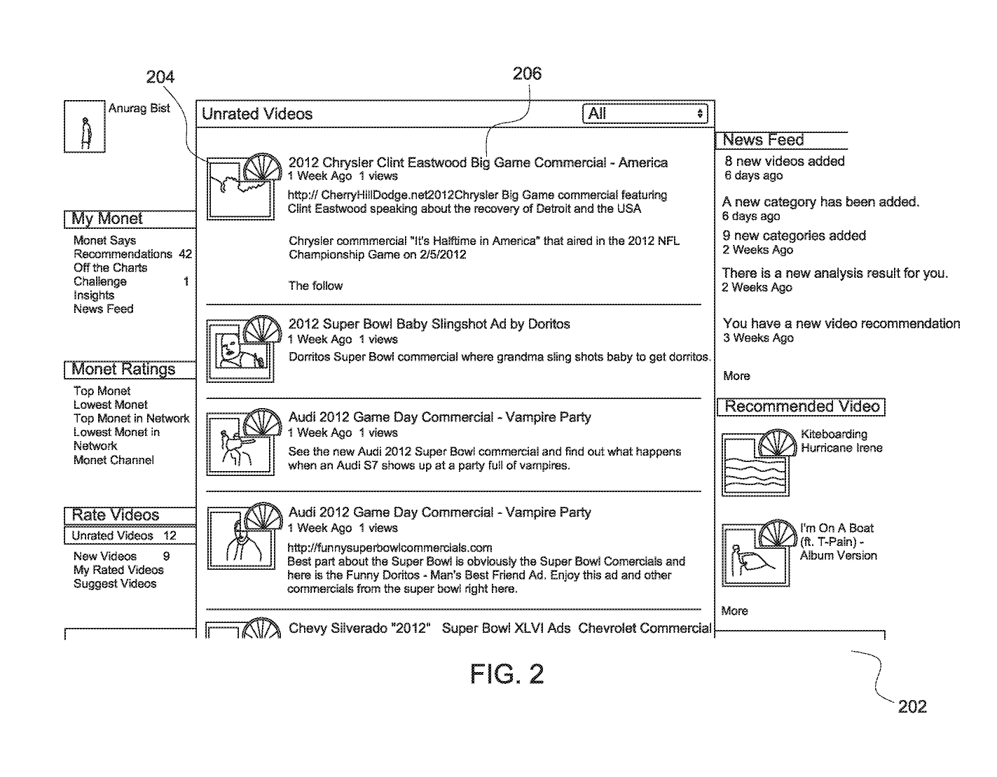

FIG. 2 shows a user's profile in an online hosted service that provides a plurality of users a platform to generate their individual profile in the connected network, in accordance with an embodiment of the present invention. The Figure shows a user's profile 202 in the online hosted service 102. The online service 102 hosted in the Internet provides the users to generate their profiles 202 that enable distribution of content to a plurality of users 110. The user has to logon to the online hosted service 102 for accessing their profiles 202. The user 110 may optionally provide various security features to their profile so as to control the access of profile 202. The user's profile 202 is viewable by other users in the online hosted service 102. The user 110 can customize their privacy setting by adding a pre-defined set of rules that determine the segment of users who can view the user profile 202. The user 110 can log in to the online hosted service 102 and can access their profile 202. The profile 202 of user contains the information of the user 110 and the details of online content or event 104 available for distribution. When the user has log in to the profile 202, the profile 202 provides a list of digital content 204 and the details of the digital content 206, that are available for the user. The digital content is stored in a repository and the online hosted service 102 provides the user 110 access to the repository through the profile 202. Alternatively, the user 110 can use the profile 202 for interacting with other users in the online hosted service 102.

While interacting with other users or while watching the digital content or event, the users leave their emotional traces in form of facial or verbal or sensory inputs. These emotional traces of the users are captured by the sensors 108 and are then processed by the behavioral classification engine 114 to classify the reaction into a plurality of intermediate states along with their intensity. The intensity is determined by assigning a numerical score to the intermediate state. These intermediate state denote the instantaneous emotional reaction of the user. These emotional states may be Happy, Sad, Disgusted, Fearful, Neutral, Angry, Surprised and other known human behaviors or emotions.

These intermediate states are then further processed through the analysis module 112 to derive a final emotional state of the user and its intensity. The Final emotional state signifies the overall impact of content or event 104 on the user.

The user's final emotional state is tagged granularly to the online content or event 104 in a frame by frame manner. A metadata link is then generated for the content that links to the details of the content or event, the final emotional state of the user for each time frame, and the average emotional state of all the users that had interacted with the content or event 104.

In an embodiment of the present invention, the module to distribute the online contents and events is a server connected to a website that has the ability to distribute digital streaming content.

In another embodiment of the present invention, after logging in the online hosted service 102, the user can upload their own digital content to a repository or cloud based storage and processing unit. The user may optionally enter his or her demographic, gender, or age information and other attributes relating to his/her trait, or about the digital content that was uploaded. The user may also optionally set the rules allowing the segment of users that can view the digital content. The system will analyze the uploaded digital content and generate emotional states based on a Rating system. It may also map the Final Emotional or Behavioral State generated by the Rating system into a set of “mapped states” that may have bearing to the attributes of the person or the uploaded video, or a particular mode of the application or the service. One mode of the application or the service could be for people to rate their uploaded video presentations. In such a mode, the application may map the “Final State” based on captured behavioral cues into “mapped states” that may be “User is Engaging”, “User is Positive”, “User is Non-Engaging”, “User is Negative”. Another mode could be where the application or the service is directed towards “Dating Web Sites”. The user will upload the digital content that could be his video profile for the Dating Website. Other users would come rate this video profile and their sensory reactions would be captured and analyzed and a Final State would be generated. In this mode this Final State would then be mapped to the “mapped states” that could be “User is Romantic”, “User is Dull”, “User is Pleasant”, “User is Happy” etc. These rated videos along with the mapped states could then be shared among friends, in other social networks based on the privacy settings chosen by the user.

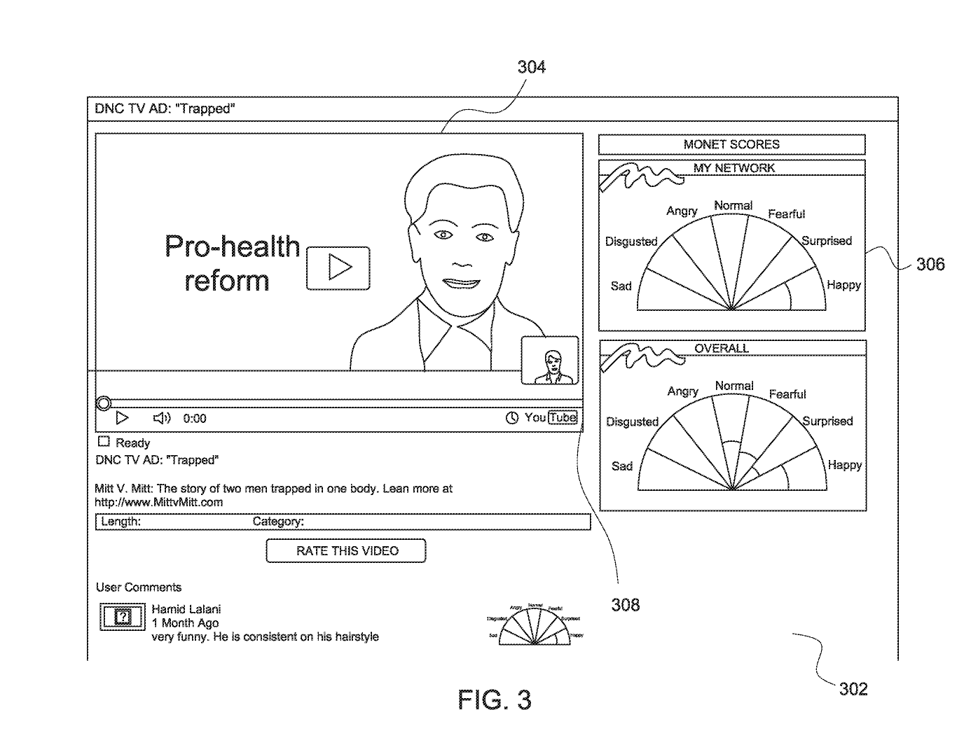

FIG. 3 shows a module in the online hosted service that displays the digital content and captures the instantaneous sensory or behavioral cues of the user, in accordance with an embodiment of the present invention. The module 302 is the application provided by the online hosted service 202 that is accessible by the user through the client devices 106 and enables the users 110 to view the distributed online contents and events 104. The module 302 is present in the online hosted service 106. FIG. 3 shows one specific video (“DNC TV Ad: Trapped”) 304 chosen by the viewer for display. Once the ad 304 is chosen and played, the sensory modules in the client device 106 gets turned on. The sensory modules then capture the instantaneous sensory and behavioral cues of the users 110. The captured inputs 308 are displayed on the module 302. These captured sensory inputs 308 are then captured, annotated with respect to the content being watched, and transferred to the Server 102 for further analysis. Alternatively the captured sensory inputs are processed in the client device 106 also. The captured sensory inputs 308 are processed by behavioral classification engine 114 and the analysis module 112 to derive the final emotional state of the user 110. The module 302 further displays the overall rating 306 of the video 304 in term of emotional reactions of the user. The overall rating 306 for the video 304 consist of the rating or emotional score of all the users in the online hosting service 102 and the emotional score for video 304 rated by the users in the user's network.

In another embodiment of the present invention, the sensory module has an ability to annotate or tag the captured sensory or behavioral inputs 308 so that they are time aligned to the distributed content or event, and transfer these annotated or tagged sensory or behavioral inputs into the server 102 where they can be analyzed.

In another embodiment of the present invention, the method is used for arriving at the final state from the initial data(sensory data and intermediate states) captured for a given user and event. The user is watching a repository of videos. Each viewing of video by the user is the “Event”. The user's reaction to watching the videos is captured via a webcam, and any audio reaction, or other sensory inputs of the user are also captured. These video, audio or other captures are the sensory data. The video capture is further processed through a emotional behavior classification engine that classifies the user's reaction into 7 different instantaneous emotions—these are the “Intermediate states”. The emotional behavior classification engine may vary from application to application, and the number of instantaneous emotions classification states (“Intermediate states”) may vary accordingly.

In an exemplary embodiment of the present invention, the “Intermediate states” corresponding to the decision of the emotional behavior engine on the captured video data of the user are Happy, Sad, Disgusted, Fearful, Angry, Surprised, and Neutral. Each “Intermediate state” is a number between 0 and 1.0 and is calibrated for every time interval of video capture (every frame captured).

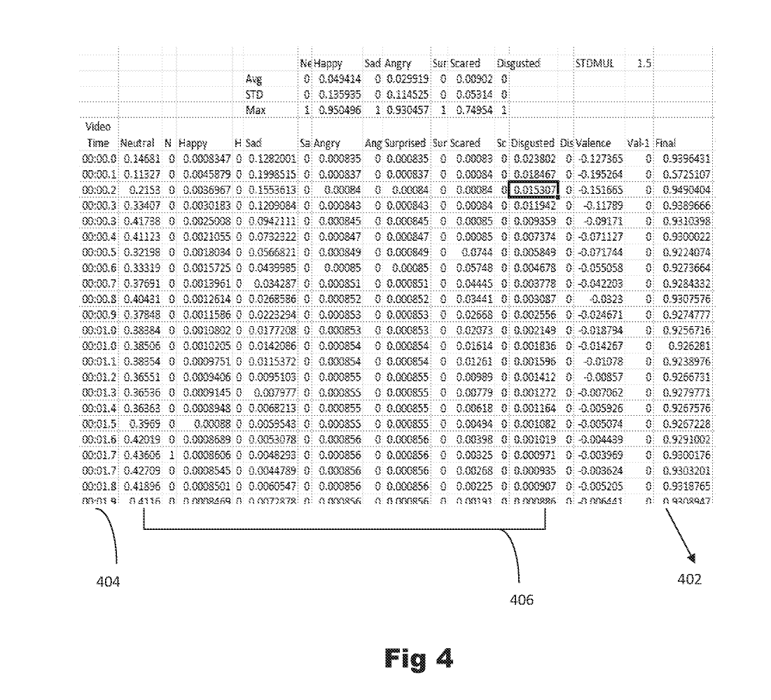

FIG. 4 shows an exemplary representation of data processed by a behavioral classification engine, in accordance with an embodiment of the present invention. The chart 402 shows the output of the Behavioral Classification Engine 114 based on the captured sensory data of the user 110 in reaction to the “Event”. The chart 402 shows the Intermediate States 406, as classified by the Emotional Classification Engine, and these are numerical values between 0.0 and 1.0 for each frame 402 of video captured. Further statistical analysis is then performed on the “Intermediate States” values 406 to derive consistent, robust classification of the Final State of the user.

In one embodiment of the invention one way of arriving at the Final State is done in the following way. For each time interval 404 (or the captured video frame) each Intermediate State data 406 goes through a mathematical operation based on the instantaneous value of that Intermediate State and its average across the whole video capture of the user in reaction to the Event. As an example, in the chart 402, the row corresponding to the Video Time 00:00.0 had 7 Intermediate States: Neutral, Happy, Sad, Angry, Surprised, Scared, and Disgusted. The Last Column Valence is another value derived from these states and is defined as (Value of Happy−(Value of Sad+Value of Angry+Value of Scared+Value of Disgusted)). Each of the Intermediate States 406 is processed according to a pre-defined set of rules. For each Intermediate State, say Neutral, the average (AVG) of entire Neutral column (for the whole captured video of the user's reaction to the Event) is calculated. The Standard Deviation (STD) of the entire Neutral column is also calculated. Based on the average score and the standard deviation, mathematical operations are performed to derive the decision on “Final State”. One way to arrive at the “Final State” could be to determine first if the “Intermediate State” is a valid state based on the variation of the instantaneous value from the standard deviation (STD) of the “Intermediate State”. If it is a valid state then a mathematical operation like calculating Valence will be used to determine the “Final State”, otherwise, the “Final State” would be zero. The determination of “Final State” could vary based on the application. In some applications the “Final State” determination could use aggregation of a particular segment of user, or a particular kind of content watched by a particular segment of the user. The actual mathematical operation to be applied on the “Intermediate States” could also vary depending on the application.

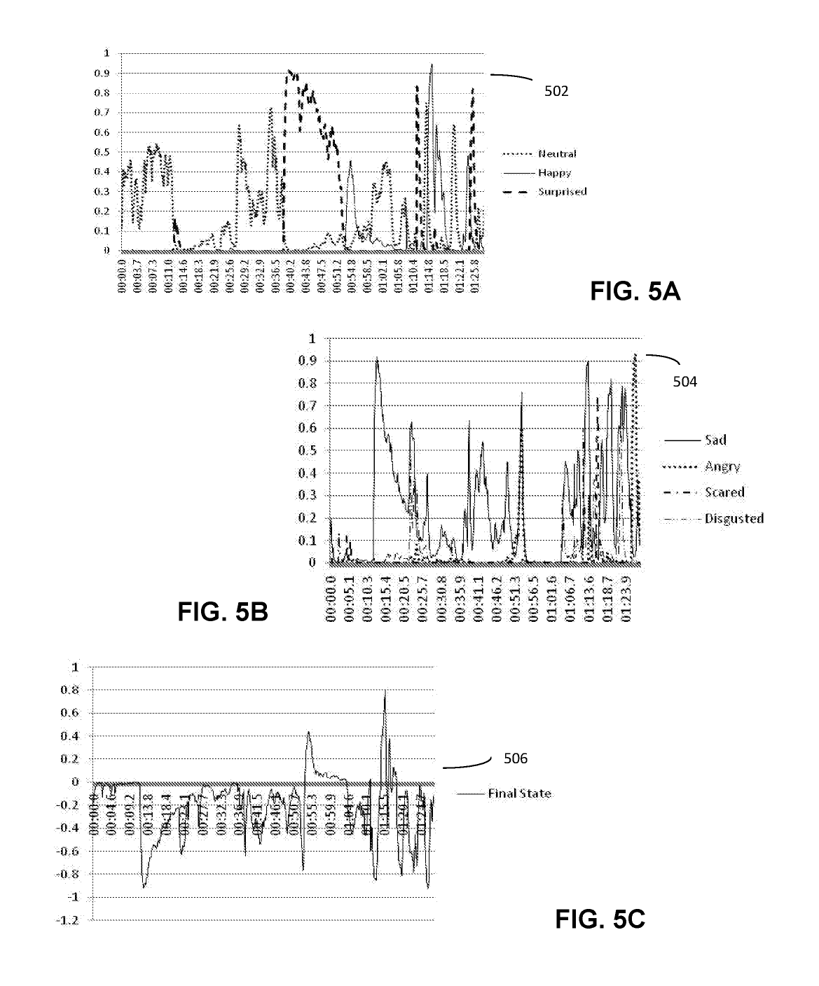

FIGS. 5(a), 5(b) and 5(c) shows a graphical representation of intermediate emotional states and the final emotional states of the user, in accordance with an embodiment of the present invention. The chart 502 shows a graph for a content displaying the intensity of a plurality of emotional states in different time frames of the content. The x-axis of the chart is the time frame or interval of the digital content whereas the y-axis denotes the intensity of a particular intermediate emotional state. In the chart 502, the intermediate states that have been displayed are Neutral, Happy and Surprised. In the chart 504, the intermediate states that have been displayed are Sad, Angry, Scared and Disgusted.

The chart 506 shows the final emotional state of the user while watching the content. The data form chart 502 and 504 are processed and then analyzed to generate the chart 506. The intensity of different intermediate emotional states is considered for computing the final emotional state of the user.

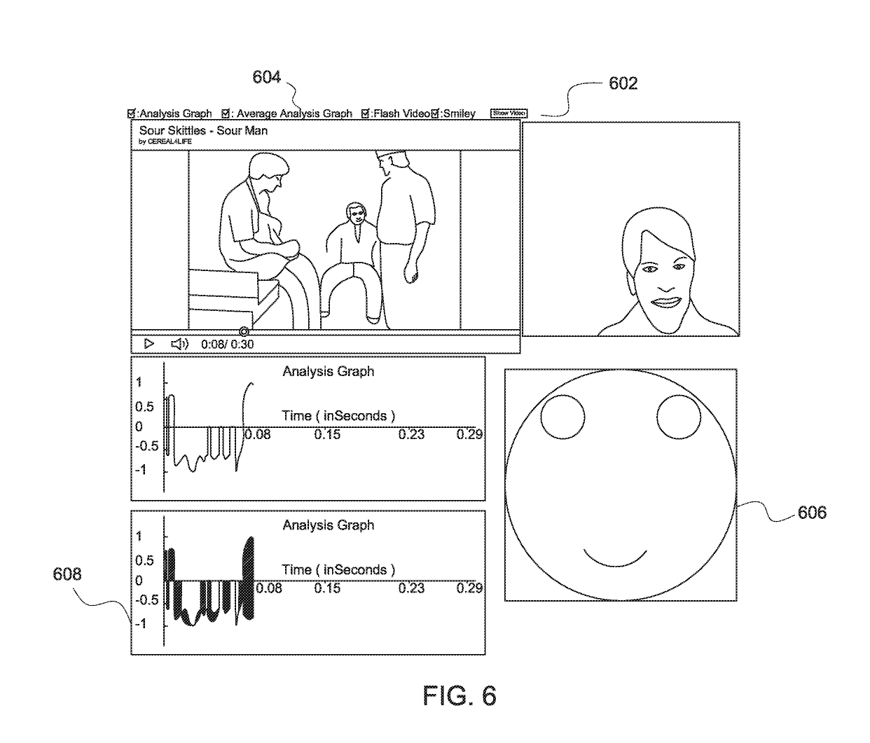

FIG. 6 shows a display dashboard that shows the analysis of the captured sensory inputs, in accordance with an embodiment of the present invention. It is a further object of the invention to provide a platform for rating and displaying the post analysis results of the digital content in a connected environment. The dashboard 602 displays the result of the analysis of captured sensory and behavioral cues 308 of the user 110. The analysis result performed by analysis module 112 is displayed on the display dashboard 602. The dashboard 602 displays the original video or content 604 being watched, emoticon 606 of the user and the analysis result graph 608 of the content.

In an embodiment of the present invention the analysis graph of the content can be on a two dimensional scale or on a multi dimensional scale.

In another embodiment of the present invention, the analysis graph 608 depicts the real-time behavioral plot of positive and negative expressions of the user on a time-stamp basis that depicts the behavior of user at a particular instance of time.

In an exemplary embodiment of the present invention, the method of the present invention can be used by Consumer Packaged Goods (CPG) companies to collect feedback from the consumer. The consumer in this process will provide their inputs that include audio, video and other sensory inputs through a web interface, which can be used as valuable data to analyze the effectiveness of the content viewed by them. The company will post the content (for example, advertisements) on which the company wants to collect feedback of consumers. The consumers' inputs are then captured through a web interface that would include video, audio or other sensory inputs, and are then transferred into the analytical engine. The analytical engine can reside on the client, on the server, or a combination of both. The system will then provide analysis of the data collected to the company's market research personnel and perhaps even to the consumers.

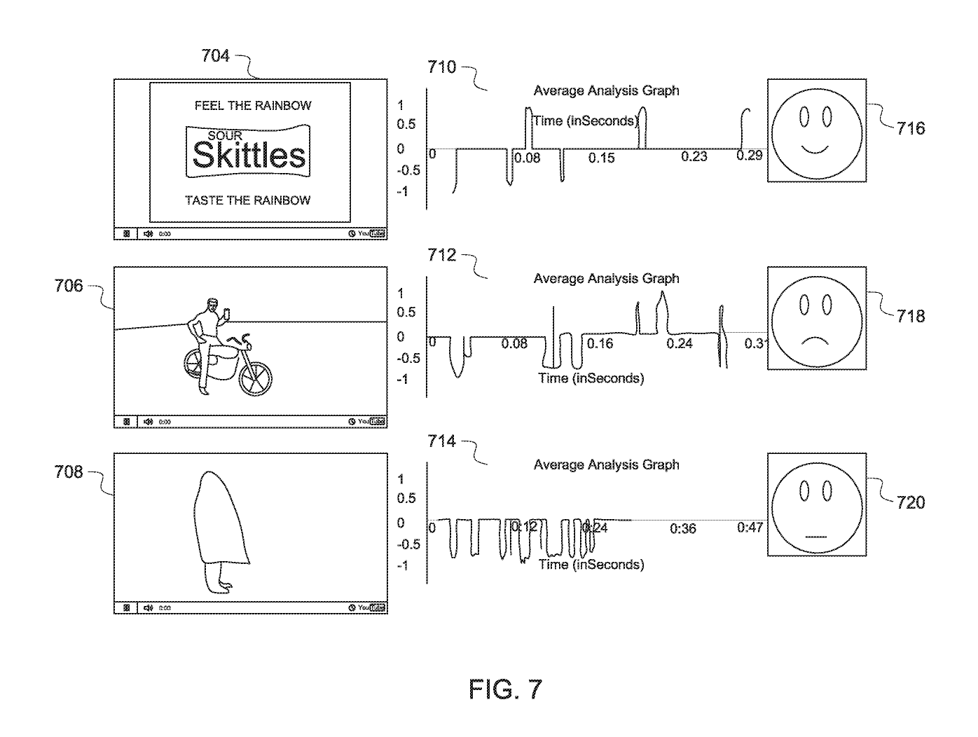

FIG. 7 illustrates an analytic dashboard for comparing a number of advertisements posted by a Consumer Packaged Goods (CPG) company, in accordance with an embodiment of the present invention. The analytics dashboard 702 shows multiple Advertisement content 704, 706 and 708 posted by a Consumer Packaged Goods (CPG) company. The Advertisements 704, 706 and 708 are posted by the Consumer Packaged Goods (CPG) Company to collect the feedback of the user 110 that can be used as valuable data to analyze the effectiveness of the content viewed by user 110. A multiple number of the users 110 viewed the Advertisement content 704, 706 and 708 and their sensory and behavioral inputs are captured through a web interface and transferred to the analysis module 112. A real-time behavioral plot 608 of positive and negative expressions on a time-stamp basis is prepared that denotes the behavior of the individual users 110 while watching the AD content 704, 706 and 708. The real-time behavioral plots 608 of the users are used to create an average real-time behavioral plot 710 on a time-stamp basis for Advertisement content 704. The average analysis graph 710, 712 and 714 represent the average reaction of the users' emotions for the Advertisement content 704, 706 and 708 respectively. The average analysis graph can then be used to compare the effectiveness of each of the Advertisement content 704, 706 and 708. A real-time emoticon 716, 718 and 720 are displayed on the display dashboard that depicts the real-time changes in subject's expressions as the time-stamp moves across the whole length of the video content 704, 706 and 708 respectively. Many other kinds of analytics could be derived based on different captured sensory inputs and several kinds of ratings could be generated based on the analytics to rank the different video content. One example of ratings could be a rating derived based on aggregate positive/negative reaction of all users that watched a particular content. Another rating could be comparing a particular behavior cue captured for all users that watched a particular content. Yet another rating could be based on some pre-determined weight age of the value captured for different sensory cues and averaging it over the length of content and then comparing the normalized value to rate different content.

The analytics dashboard 502 provides a comparison of Advertisement content 704, 706 and 708 and thus provides a company's market research personnel and to the users information on the effectiveness of the content. The analysis can be useful for the company in case if it requires feedback of consumers for its new initiatives such as changes in websites, web or TV advertisements.

In an embodiment of the present invention, the method of the present invention will enable a rating method and system that allows collecting and organizing the individual's non-verbal cues as a reaction to the event on the web. The system collects behavioral, emotional and other sensory cues as inputs from subjects in reaction to watching any web content (a web page, a picture, a YouTube video, any movie, or any other kind of content). These sensory cues will be processed and presented as an extension of ‘like’ button on the basis of the analytics results of the content.

In another exemplary embodiment of the present invention, the method can be used for creating a platform for collecting voter feedback for political polling, campaigns and research firms. The method involves analyzing a streaming video content of the Political Advertisement. An average real-time behavior plot of positive and negative expressions is developed to describe the behavior of all users on a time-stamp basis that viewed the advertisement. An analytic score based on above analytics can provide the political campaign managers yet another quick and objective data point that can drive their decisions.

Political Campaigns are very dynamic requiring rapid response and needing ability to craft messages that can be tested out with a quick turnaround. These analytics provide a quick analytical comparison of the effectiveness of several messages before committing significant resources for broader distribution. A campaign or a political research firm can develop a set of participants who are willing to rate the political advertisements. These participants provide their behavioral inputs while they are viewing the advertisements. The voter data with their demographic information can be used to create raters representing each voter segment that needs to be analyzed. The participants' inputs are collected and analyzed with results provided in a very cost-effective and rapid turn-around fashion. The method can be used to make various decisions like helping choose from competing advertisements, or to test the suitability of an advertisement at different voter segments.

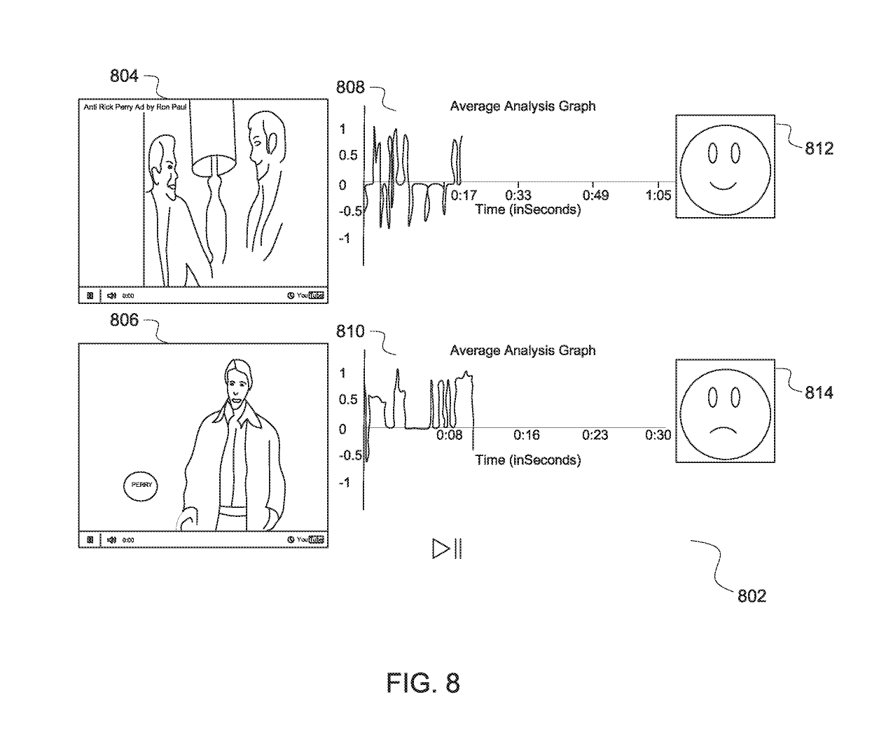

FIG. 8 illustrates an analytic dashboard for comparing effectiveness of a set of advertisement of a political campaign in accordance with an embodiment of the present invention. The analytic dashboard 802 shows streaming videos 804 and 806 of two competing political advertisements that are being analyzed. The users while viewing the Advertisements 804 and 806 provides input in form of sensory and behavioral cues. These inputs are analyzed to create an average real-time behavior plot 808 and 810 of positive and negative expressions of the users on a time-stamp basis that viewed the Advertisements 804 and 806. The analytic dashboard 802 also shows a real time emoticon 812 and 814 depicting the real-time changes in expressions as the time-stamp moves across the whole length of the videos 804 and 806 respectively. The analytic score on the analytic dashboard 802 provides the political campaign managers another quick and objective data point that can drive their decisions.

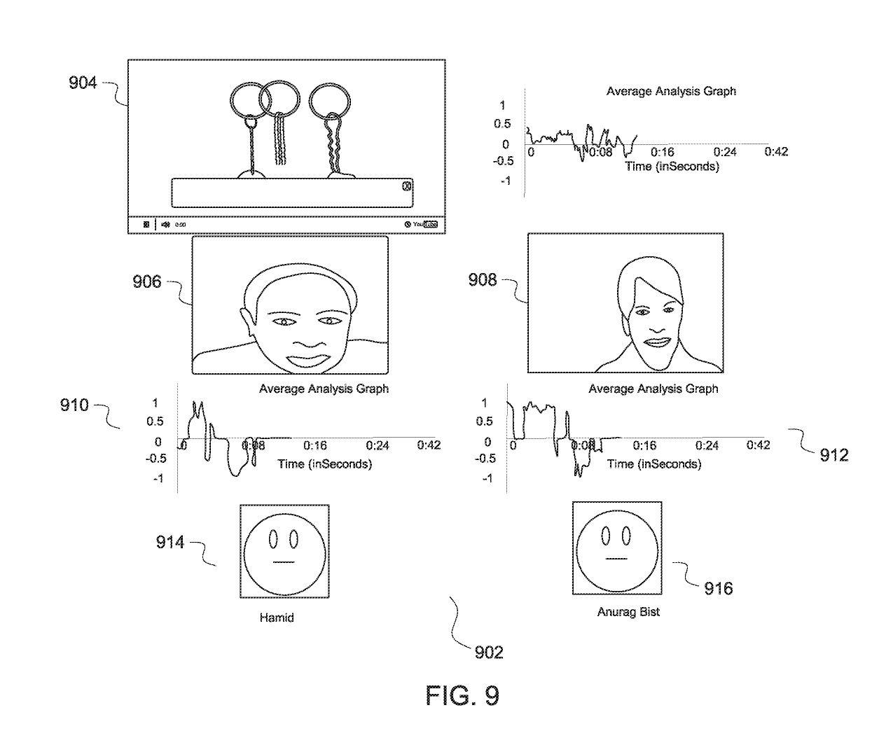

FIG. 9 illustrates an analytic dashboard showing the impact of an advertisement on different segment of users, in accordance with an embodiment of the present invention. The analytic dashboard 902 shows a video content 904 viewed by user segment 906 and 908. The viewer 906 represents a specific user segment A and the user 908 represents a specific user segment B. While viewing the video 904, the sensory and behavioral inputs of each user 906 and 908 are captured and analyzed to generate a real time behavioral plot of positive and negative expression on a time stamp basis. The real-time behavioral plot of user 906 is shown as real-time graph 910 and the behavioral plot of user 908 is shown as real-time graph 912. The analytic dashboard 902 also shows the real time emoticon 914 and 906 that represent the real-time changes in expressions as the time-stamp moves across the whole length of the video 904. As the user 906 represents a particular segment A and the user 908 represents user segment B, the behavioral analysis graph of each user corresponds to its users segment. The analytic dashboard 902 also displays the average real-time behavioral plot of positive and negative expressions of the users on a time-stamp basis. The result on the analytic dashboard 902 can be used for comparing the impact of a video content on a particular segment of the users.

1. A system for capturing a user's behavioral reaction to content and for rating the content on the basis of a user's emotional reaction comprising:
an online hosted service in a server for distributing one or more online content or event to one or more client device that enables a user to access the one or more online content or event and captures in real time a facial cues of the user in form of a video input using a camera while the user is viewing the content or performing the event, said facial cues represents an instantaneous emotional reaction of the user to the content or the event;
an emotion recognition engine configured to classify the facial cues of the user into a plurality of intermediate emotional sub-states and assigns a numerical score, each of said plurality of emotional sub-states with the numerical score represent the intensity of emotional sub-state at a given time frame;
an analysis module in the server configured to determine a final emotional state of the user and the intensity of the final emotional state at the given time frame by calculating valence of the plurality of intermediate emotional sub-states and the associated numerical score; and
a display dashboard in the server configured to display the one or more contents tagged granularly with the final emotional state and the intermediate emotional sub-states data at respective time frames.

2. The system of claim 1 wherein a profile is generated for the user and wherein the profile is updated to include the details of the content, the numerical score of each of the plurality of intermediate emotional sub-states, and the intensity of final emotional state.

3. The system of claim 1 wherein the the content or the event is selected from the group consisting of video download, video viewing, communications, video communications, and social networking services.

4. (canceled)

5. The system of claim 1 wherein the plurality of intermediate emotional sub-states are Happy, Sad, Disgusted, Surprised, Angry, Neutral, Fearful and human behavior or emotions.

6. The system of claim 1 wherein the analysis module is located in a client device or in an online hosted service.

7. The system of claim 1 wherein the client device is a mobile phone, a smartphone, a laptop, a camera with WiFi connectivity, a desktop, a tablet computer, or a sensory device with connectivity.

8. The system of claim 2 wherein a profile of the user is provided with a privacy setting.

9.-35. (canceled)
